(19) United States
(12) Patent Application Publication
(10) Pub. No.: US 2015/0052518 A1
(43) Pub. Date: Feb. 19, 2015

(54) METHOD AND SYSTEM FOR PRESENTING AND MANAGING STORAGE IN A VIRTUAL MACHINE ENVIRONMENT

(71) Applicant: NETAPP, INC., Sunnyvale, CA (US)

(72) Inventors: Daniel Andrew Sarisky, Cary, NC (US); Deepak Zac Thomas, Cary, NC (US); Nagender Somavarapu, Sunnyvale, CA (US); Santosh C. Lolayekar, Saratoga, CA (US)

(73) Assignee: NETAPP, INC., Sunnyvale, CA (US)

(21) Appl. No.: 13/966,549

(22) Filed: Aug. 14, 2013

(51) Int. Cl. G06F 9/455

(52) U.S. Cl. CPC G06F 9/45533
USPC 718/1

(57) ABSTRACT

Method and system for presenting storage in a virtual machine environment are provided. A storage volume is allocated to an existing profile, when the existing profile meets attributes for a requested storage and a new profile is generated when an existing profile does not meet the attributes and the storage volume is assigned to the new profile.

### TECHNICAL FIELD

The present disclosure relates to storage systems in a virtual machine environment.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple users with access to shared data, backing up data and others.

A storage system typically includes at least one computing system executing a storage operating system for storing and retrieving data on behalf of one or more client computing systems (“clients”). The storage operating system stores and manages shared data containers in a set of mass storage devices.

Storage systems are being used extensively in virtual environments where a physical resource is time-shared among a plurality of independently operating processor executable virtual machines. Typically, storage space is presented to a virtual machine as a virtual hard disk (VHD) file. A storage drive is then presented to a user via a user interface within a virtual machine context. The user can use the storage drive to access storage space to read and write information. Continuous efforts are being made to better manage and utilize storage resources in a virtual machine environment.

### BRIEF DESCRIPTION OF THE DRAWINGS

The foregoing features and other features will now be described with reference to the drawings of the various embodiments. In the drawings, the same components have the same reference numerals. The illustrated embodiments are intended to illustrate, but not to limit the present disclosure. The drawings include the following Figures:

FIG. 1A shows an example of an operating environment for the various embodiments disclosed herein;

FIG. 1B shows an example of presenting storage space, according to one embodiment;

FIG. 2B-2C show examples of data structures, used according to one embodiment;

FIGS. 2D-2G show various process flow diagrams, according to the various embodiments of the present disclosure;

FIG. 3 is an example of a storage node used in the cluster of FIG. 2A, according to one embodiment;

FIG. 4 shows an example of a storage operating system, used according to one embodiment; and

FIG. 5 shows an example of a processing system, used according to one embodiment.

### DETAILED DESCRIPTION

As preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device, in accordance with the claimed subject matter.

In one embodiment, a method and system for presenting storage in a virtual machine environment are provided. A storage volume is allocated to an existing storage profile, when the existing profile meets attributes for a requested storage. A new storage profile is generated when an existing profile does not meet the attributes and the storage volume is assigned to the new profile.

System 100:

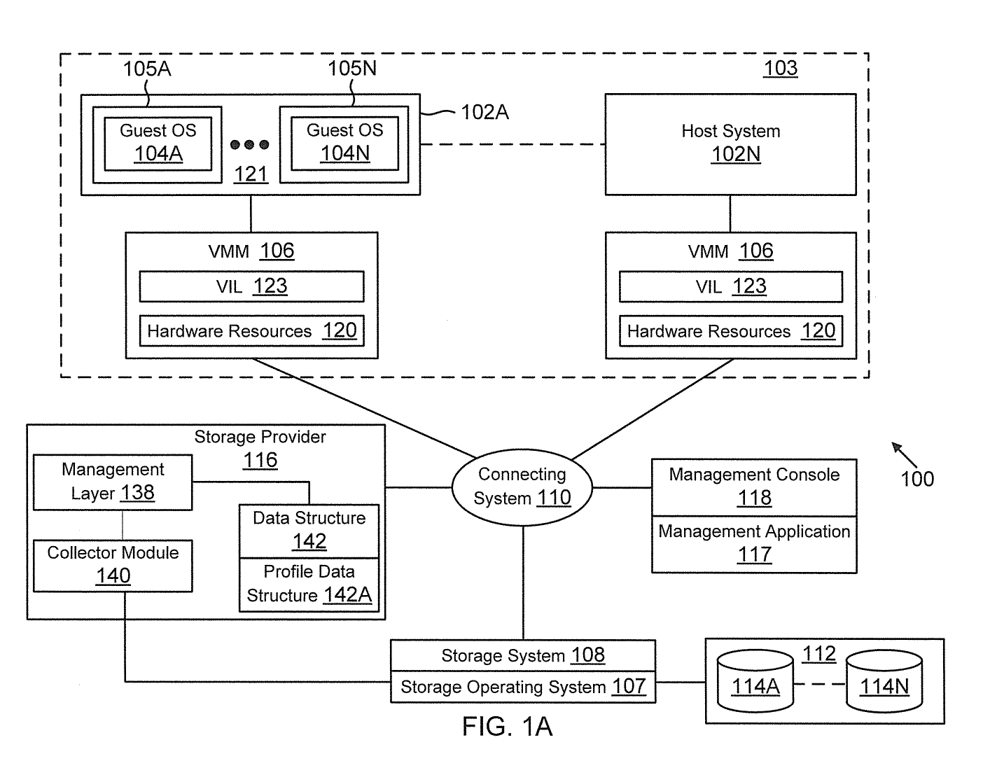

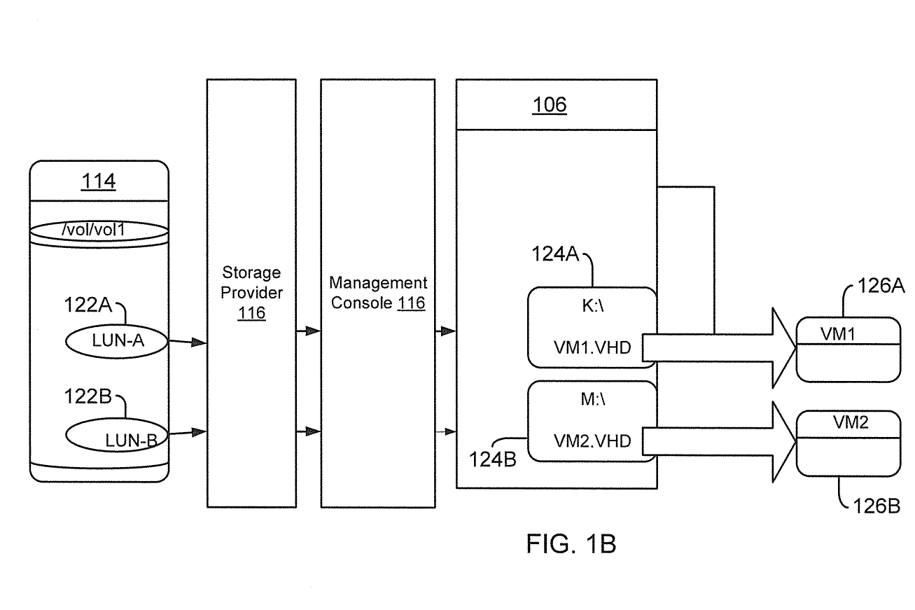

FIG. 1A shows an example of a system 100, where the adaptive embodiments disclosed herein may be implemented. System 100 includes a virtual machine environment where a physical resource is time-shared among a plurality of independently operating processor executable virtual machines (VMs). Each VM may function as a self-contained platform, running its own operating system (OS) and computer executable, application software. The computer executable instructions running in a VM may be collectively referred to herein as “guest software.” In addition, resources available within the VM may be referred to herein as “guest resources.”

The guest software expects to operate as if it were running on a dedicated computer rather than in a VM. That is, the guest software expects to control various events and have access to hardware resources on a physical computing system (may also be referred to as a host platform) which maybe referred to herein as “host hardware resources”. The host hardware resource may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host platform.

In one embodiment, system 100 may include a plurality of computing systems 102A-102N (may also be referred to as a host platform 102 or server 102) communicably coupled to a storage system 108 executing a storage operating system 107 via a management console 118 and/or a connection system 110 such as a local area network (LAN), wide area network (WAN), the Internet and others. As described herein, the term “communicably coupled” may refer to a direct connection, a network connection, or other connections to enable communication between devices.

System 100 also includes a storage provider 116 that interfaces with the management console 118 and the storage operating system 107. The storage operating system 107 provides storage space related information and the storage provider 116 uses the information to manage and present storage to management console 118, as described below in detail.

Host platform 102 includes a processor executable virtual execution environment 121 executing a plurality of VMs 105A-105N. VMs 105A-105N execute a plurality of guest OS 104A-104N (may also be referred to as guest OS 104) that share hardware resources 120. As described above, hardware resources 120 may include CPU, memory, I/O devices, storage or any other hardware resource.

In one embodiment, host platform 102 interfaces with a virtual machine monitor (VMM) 106 that includes, for example, a processor executed hypervisor layer provided by VMWare Inc., a Hyper-V layer provided by Microsoft Corporation of Redmond, Wash. or any other layer type. VMM 106 presents and manages the plurality of guest OS 104A-104N executed by the host platform 102. The VMM 106 may include or interface with a virtualization layer (VIL) 123 that provides one or more virtualized hardware resource to each guest OS 104A-104N.

In one embodiment, VMM 106 may be executed by host platform 102 with VMs 105A-105N. In another embodiment, VMM 106 may be executed by an independent stand-alone computing system, often referred to as a hypervisor server or VMM server and VMs 105A-105N are presented on another computing system. It is noteworthy that various vendors provide virtualization environments, for example, VMware Corporation, Microsoft Corporation and others. The generic virtualization environment described above with respect to FIG. 1A may be customized depending on the virtual environment provider.

In one embodiment, the management console 118 executes a processor executable management application 117 for managing and configuring various elements of system 100. Management console 118 may be referred to as “Vcenter” in a virtual environment 103 provided by VmWare Corporation. The management console 118 communicates with the host platforms, VMM 106 and storage provider 116 for managing storage presented to various VMs.

In one embodiment, VMM 106 may request storage space for a VM from the management console 118. The management console 118 may then interface with the storage provider 116 for the requested storage space.

In one embodiment, storage provider 116 includes a management logic layer 138. The management layer 138 interfaces with the storage system 108 and management console 118. The management logic layer 138 maintains a data structure 142 and a profile data structure 142A that are described below in detail. Information at data structure 142 may be based on storage information that is gathered by a collector module (or a storage system interface) 140 from storage operating system 107. It is noteworthy that although management logic layer 138 and the collector module 140 are shown as separate modules, they may be integrated into a single module or segregated into more than two modules.

In one embodiment, the storage system 108 has access to a set of mass storage devices 114A-114N (may be referred to as storage devices 114) within at least one storage subsystem 112. The mass storage devices 114 may include writable storage device media such as magnetic disks, video tape, optical, DVD, magnetic tape, non-volatile memory devices for example, self-encrypting drives, flash memory devices and any other similar media adapted to store information. The storage devices 114 may be organized as one or more groups of Redundant Array of Independent (or Inexpensive) Disks (RAID). The embodiments disclosed are not limited to any particular storage device or storage device configuration.

The storage system 108 provides a set of storage volumes for storing information at storage devices 114. The storage operating system 107 can present or export data stored at storage devices 110 as a volume, or one or more qtree sub-volume units to management application 117. Each volume may be configured to store data files (or data containers or data objects), scripts, word processing documents, executable programs, and any other type of structured or unstructured data. From the perspective of client systems, each volume can appear to be a single storage drive. However, each volume can represent the storage space in at one storage device, an aggregate of some or all of the storage space in multiple storage devices, a RAID group, or any other suitable set of storage space.

The storage devices or storage space at storage devices 114 may be presented as a “logical unit number” (LUN) where a LUN may refer to a logical data container that appears as a storage device to a host (client) but may have distributed access across multiple storage devices of storage system 108.

The storage system 108 may be used to store and manage information at storage devices 114 based on a client request. The request may be based on file-based access protocols, for example, the Common Internet File System (CIFS) protocol or Network File System (NFS) protocol, over the Transmission Control Protocol/Internet Protocol (TCP/IP). Alternatively, the request may use block-based access protocols, for example, the Small Computer Systems Interface (SCSI) protocol encapsulated over TCP (iSCSI) and SCSI encapsulated over Fibre Channel (FCP).

In a typical mode of operation, a client (for example, a VM) transmits one or more input/output (I/O) commands, such as an NFS or CIFS request, over connection system 110 to the storage system 108. Storage system 108 receives the request, issues one or more I/O commands to storage devices 114 to read or write the data on behalf of the client system, and issues an NFS or CIFS response containing the requested data over the network 110 to the respective client system.

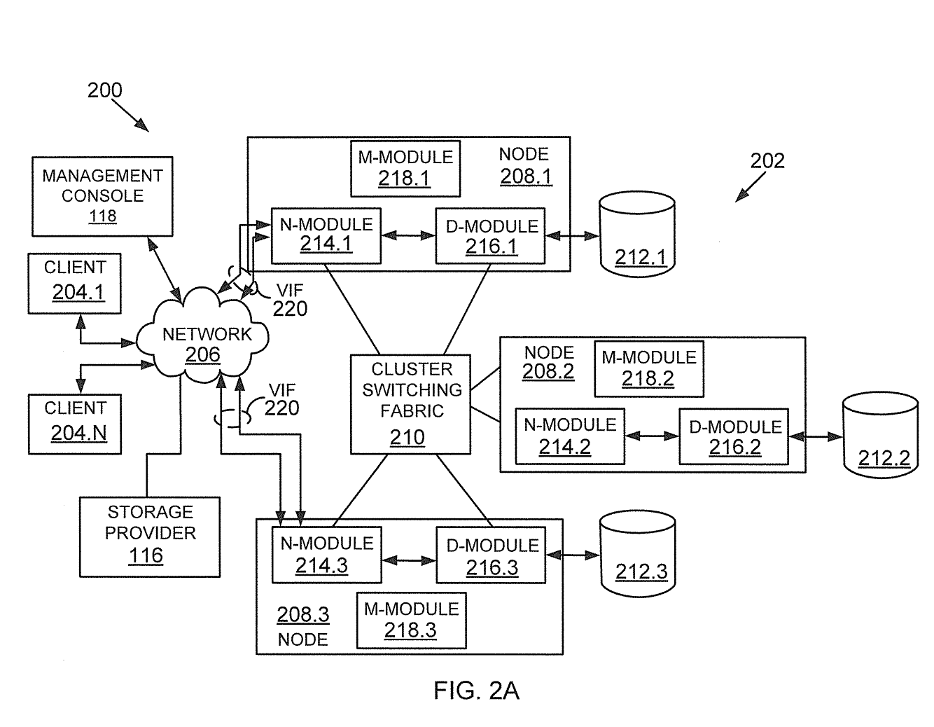

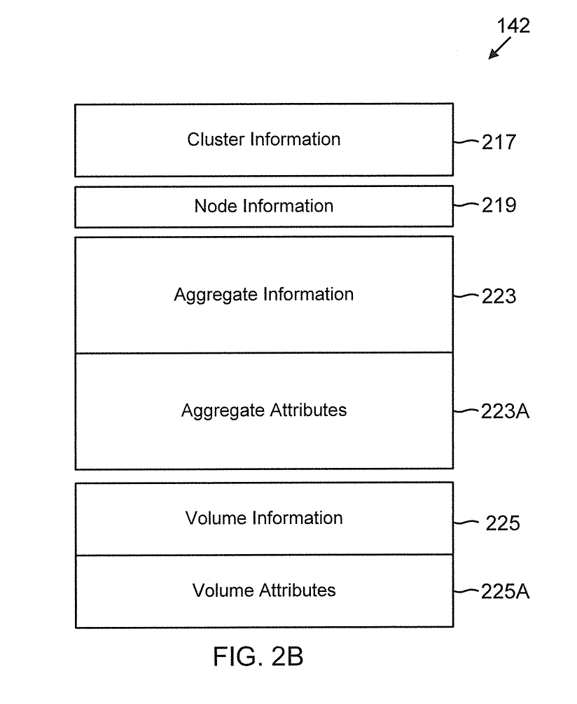

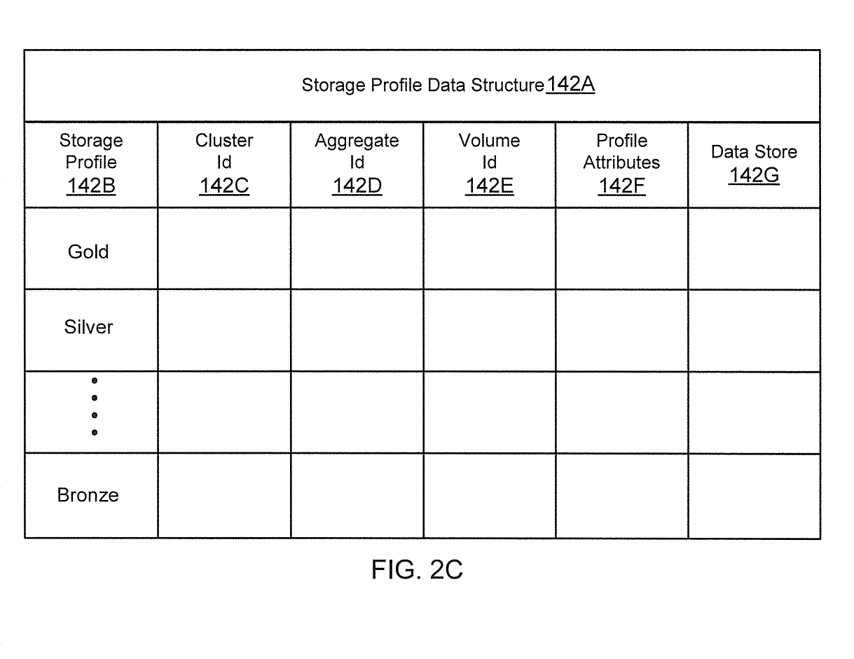

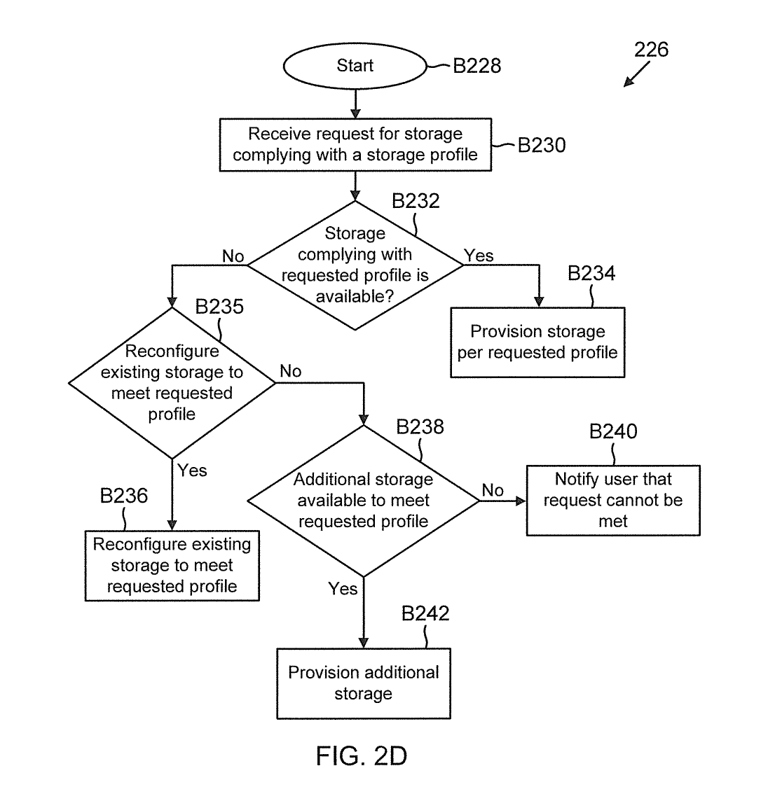

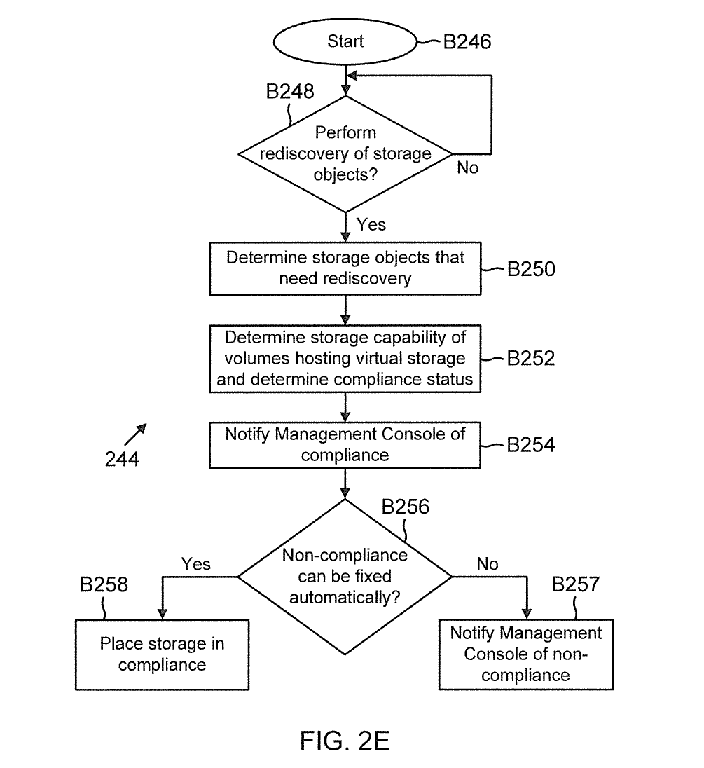

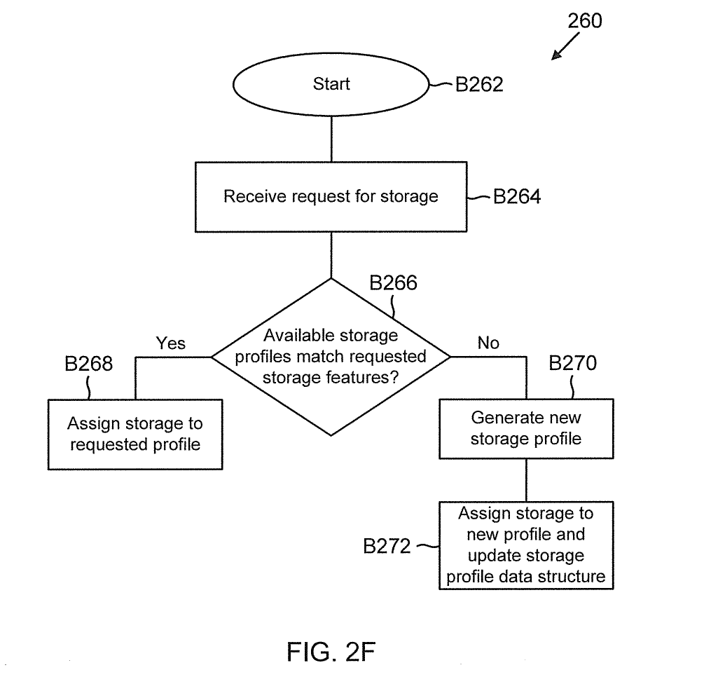

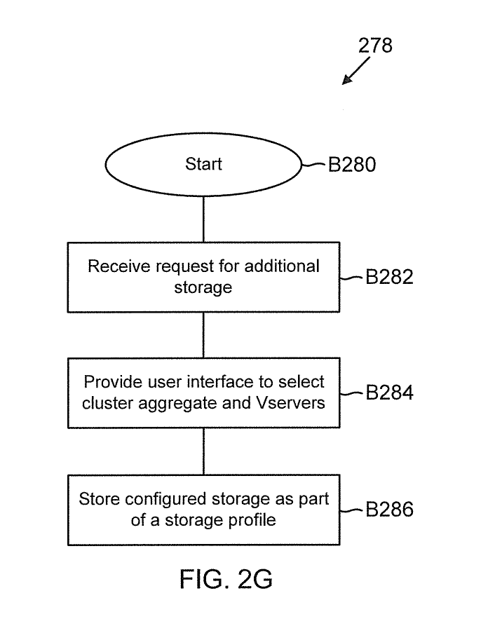

Although storage system 108 is shown as a stand-alone system, i.e. a non-cluster based system, in another embodiment, storage system 108 may have a distributed architecture; for example, a cluster based system that is described below in detail with respect to FIG. 2A.

FIG. 1B shows an example of presenting logical storage space to one or more virtual machines. Storage system 108 presents storage space at storage device 114 as a LUN to storage provider 116. The storage provider 116 then provides storage space to management application 117. The management application 117 then presents the LUNs to VMM 106 (for example, a Hypervisor server). For example, LUN-A 122A and LUN-B 122B are presented to VMM 106 that hosts a plurality of VMs 126A (VM1)-126B (VM2), similar to VMs 105A-105N.

In another embodiment, the LUNs may be presented to the storage provider 116 that directly presents the LUNs to VMM 106. In yet another embodiment, the LUNs may be presented directly to VMM 106. The embodiments disclosed herein are not limited to any entity presenting logical storage space.

VMM 106 in general and VIL 123 in particular, creates a file system for example, a NTFS file system on the LUNs and generates one or more virtual hard drive (VHD) files for each LUN. The user is presented with a storage drive within a virtual machine. For example, the VHD file VM1.VHD 124A is created on LUN-A 122A and then presented as drive K:\ to VM1 126A (similar to 105A). A user using VM1 126A uses K:\ to access storage space for reading and writing information. Similarly, VM2.VHD 124B is created on LUN-B 122B and appears as M:\ drive for VM 126B (similar to VM 105A). A user using VM2 126A uses M:\ drive to store information.

In some instances, a file system for the LUNs is not created and instead the LUNs are presented directly to the VM as a storage drive. The storage drives in such an instance may be referred to as “pass through” disks. The terms VHD and pass through disks as used herein for presenting a virtual storage drive are used interchangeably throughout this specification.

Clustered System:

FIG. 2A shows a cluster based storage environment 200 having a plurality of nodes for managing storage devices, according to one embodiment. Storage provider 116 interfaces with various nodes in the storage environment 200 for maintaining data structures 142 and 142A, as described below in detail.

Storage environment 200 may include a plurality of client systems 204.1-204.N (or virtual machines 105A-105N), a clustered storage system 202 (similar to storage system 108) and at least a network 206 communicably connecting the client systems 204.1-204.N and the clustered storage system 202. As shown in FIG. 2A, the clustered storage system 202 includes a plurality of nodes 208.1-208.3, a cluster switching fabric 210, and a plurality of mass storage devices 212.1-212.3 (may be referred to as 212 and similar to storage device 114).

Each of the plurality of nodes 208.1-208.3 is configured to include an N-module, a D-module, and an M-Module, each of which can be implemented as a processor executable module. Specifically, node 208.1 includes an N-module 214.1, a D-module 216.1, and an M-Module 218.1, node 208.2 includes an N-module 214.2, a D-module 216.2, and an M-Module 218.2, and node 208.3 includes an N-module 214.3, a D-module 216.3, and an M-Module 218.3.

The N-modules 214.1-214.3 include functionality that enable the respective nodes 208.1-208.3 to connect to one or more of the client systems 204.1-204.N over the computer network 206, while the D-modules 216.1-216.3 connect to one or more of the storage devices 212.1-212.3. Accordingly, each of the plurality of nodes 208.1-208.3 in the clustered storage server arrangement provides the functionality of a storage server.

The M-Modules 218.1-218.3 provide management functions for the clustered storage system 202. The M-Modules 218.1-218.3 collect storage information regarding storage devices 212 and makes it available to storage provider 116, according to one embodiment. The information includes aggregate information, volume information, and volume attributes and features that may be enabled on a volume, for example, de-duplication, data protection, data mirroring, backup and other features.

A switched virtualization layer including a plurality of virtual interfaces (VIFs) 220 is provided to interface between the respective N-modules 214.1-214.3 and the client systems 204.1-204.N, allowing storage 212.1-212.3 associated with the nodes 208.1-208.3 to be presented to the client systems 204.1-204.N as a single shared storage pool.

Each of the nodes 208.1-208.3 is defined as a computing system to provide application services to one or more of the client systems 204.1-204.N. The nodes 208.1-208.3 are interconnected by the switching fabric 210, which, for example, may be embodied as a switch or any other type of connecting device.

Although FIG. 2A depicts an equal number (i.e., 3) of the N-modules 214.1-214.3, the D-modules 216.1-216.3, and the M-Modules 218.1-218.3, any other suitable number of N-modules, D-modules, and M-Modules may be provided. There may also be different numbers of N-modules, D-modules, and/or M-Modules within the clustered storage system 202. For example, in alternative embodiments, the clustered storage system 202 may include a plurality of N-modules and a plurality of D-modules interconnected in a configuration that does not reflect a one-to-one correspondence between the N-modules and D-modules.

Each client system may request the services of one of the respective nodes 208.1, 208.2, 208.3, and that node may return the results of the services requested by the client system by exchanging packets over the computer network 206, which may be wire-based, optical fiber, wireless, or any other suitable combination thereof. The client systems may issue packets according to file-based access protocols, such as the NFS or CIFS protocol, when accessing information in the form of files and directories.

FIG. 2B shows an example of a hierarchical data structure 142 used by storage provider 116 for providing storage space to clients. At a top-level, data structure 142 stores cluster information 217. Cluster information may be for cluster 200 and may include an identifier identifying the cluster, the different nodes within the cluster, protocols used within the cluster and any other information regarding the cluster.

Below, the cluster level, data structure 142 includes node information 219 that may be used to store information regarding the various cluster nodes, for example, 208.1-208.3. The node information identifies the nodes, the storage devices that are assigned to a node and any other information.

Data structure 142 also stores information regarding aggregates (aggregate information 223) within cluster 200. Each aggregate is a logical structure that includes a plurality of storage volumes. Aggregate information 223 identifies each aggregate and stores aggregate attributes 223A. Aggregate information 223 may identify each storage volume within each aggregate and any other aggregate related information.

Data structure 142 also stores storage volume information 225 and the attributes for each volume as 225A. Volume information 225 may include an identifier that identifies the volume, information regarding a node that manages the volume, aggregate identifier to which the volume may belong and any other information. Volume attribute information 225A may store information regarding permissions associated with the volume, features that are enabled or can be enabled on the volume, for example, de-duplication, data mirroring, and other features. The attributes are set up when a volume is configured and may be changed by a user.

FIG. 2C shows an example of a storage profile data structure 142A, according to one embodiment. The storage profile data structure 142A may be used to manage storage profiles based on storage attributes that are associated with storage presented to the VMs, according to one embodiment. Column 142B may be used to store different storage profiles. For example, storage profiles may be categorized as “Gold”, “Silver”, “Bronze” and others. Each storage profile is associated with a storage volume (Column 142E), which is part of an aggregate (142D) and a cluster (142C). The storage profiles may have varying attributes that are provided in column 142F. Column 142G identifies the storage with a corresponding storage profile in column 142B as a “data store” or a storage instance. The storage is presented as a LUN or a mapped NFS mount point and column 142G identifies the storage instance.

Storage provider 116 uses data structure 142 and 142A for managing storage profiles and presenting storage space to management console 118 (and/or VMs), according to one embodiment. The various processes associated with using the data structures are described below with respect to FIG. 2D-2G.

FIG. 2D shows a process 226 for providing storage based on a storage policy/profile, according to one embodiment. The process begins in block 228, when management console 118, storage provider 116 and the storage system 108 are operational and initialized.

In block B230, the management console 118 sends a request for storage complying with a storage policy or storage profile to the storage provider 116. The request may also specify storage attributes and a storage size. As mentioned above, storage provider 116 presents storage as being part of different storage profiles. For example, storage provider 116 may have a “Gold” level storage or Tier I storage; “Silver” level storage or Tier II storage; “Bronze” level storage and other storage levels. Each storage profile has certain attributes and features. For example, one profile may include data de-duplication, mirroring, security features, while another profile may have fewer attributes and features. The various storage profile and associated capabilities are stored at profile data structure 142A maintained by management logic layer 138 and described above in detail.

In block B232, the management logic layer 138 scans data structure 142A to determine if any storage volume (i.e. storage) complying with the requested storage profile and storage size is available. If available, then the storage volume is provisioned and flagged as being within the requested profile, for example, as Gold level storage. The data structure 142A is then updated to ensure that future requests for the same storage level can be assigned from the storage volume, as long as storage space associated with the storage volume is available.

If the existing storage does not meet the requested storage profile, then the management logic layer 138 evaluates data structure 142A to determine if certain storage volumes can be reconfigured to meet the requested storage profile. Management layer 138 determines if a previous request was for a lower level storage, for example, silver level but was assigned gold level storage. In that case, the management layer 138 can swap (i.e. reconfigure) the storage for the previous, lower level request and assign a higher level storage for the request in block B230.

If storage can be re-configured, then in block B236, storage provider 116 reconfigures storage to comply with the request. If the existing storage cannot be reconfigured, then in block B238 the management logic layer 138 determines if any additional storage may be available for any existing aggregate by expanding an existing storage volume or provisioning new storage. Management logic 138 determines this by interfacing with the storage system 108 that maintains aggregates/storage volumes. If yes, then additional storage is provisioned in block B242, otherwise, in block B240, the user is notified that the request cannot be met.

FIG. 2E shows a process 244 for monitoring storage and compliance with storage profiles maintained by storage provider 116, according to one embodiment. One reason for executing process 244 is to ensure that storage is being optimally used. For example, in some instances, if Gold storage is assigned for a Silver storage request, then Gold storage may not be available for Gold storage request at a later time. Process 244 ensures that storage space is not being under-utilized.

Process 244 begins in block B246 when VMs within a VM cluster are operating. Storage provider 116 is also operational and interfacing with storage system 108.

In block B248, the management logic layer 138 initiates a rediscovery operation of various storage objects (or storage volumes). The rediscovery may be based on a message from storage operating system 107 when the storage operating system 107 may have performed an operation, for example, moving a volume from one storage location to another or migrating or relocating an aggregate. The rediscovery of storage objects may be initiated based on a periodic schedule that is configured using a management application. As an example, re-discovery of storage objects may be initiated by a user request received via a user interface from the management console 118.

If re-discovery needs to be performed, then in block B250, the management logic 138 determines what storage objects need to be re-discovered. In one embodiment, all storage volumes are rediscovered based on a periodic schedule. In another embodiment, a storage volume is selected for rediscovery if the storage operating system 107 notifies the storage provider 116 that the storage volume has changed. In yet another embodiment, the management console 118 may request rediscovery of certain storage volumes.

In block B252, the management logic layer 138 obtains the current capability of storage volumes that are presented as VHDs to VMs. The storage operating system 107 maintains this information at one or more data structures. The data structure maintained by the storage operating system 107 stores a volume identifier (Volume Id) and different volume attributes, for example, size, location, if certain features, for example, de-duplication, mirroring or other features are enabled. The management logic 138 obtains this information and updates data structure 142/142A. Based on the update, the management logic 138 determines if the storage presented to VMs is in compliance with the requested profile. If all the storage is in compliance, then the management logic 138 notifies the management console 118.

If any storage is not in compliance, after the rediscovery, then in block B256, the management logic 138 determines if the storage can be brought into compliance by moving one or more VHDs to another volume, modifying any volume properties and others. If yes, then the VHDs affected by the modifications are placed in compliance in block B258.

If the VHDs cannot be automatically brought into compliance, then the management console 118 is notified in block B256.

FIG. 2F shows a process 260 for generating a storage profile based on a selected storage, according to one embodiment. The process begins in block B280, when the management console 118, storage provider 116 and storage system 108 are all operational.

In block B262, the storage provider 116 is notified of storage that is selected by a user. The storage may be selected via a user interface provided by management console 118.

In block B264, the management layer 138 obtains storage capability information for the selected storage. The storage capability information includes features that are enabled, for example, de-duplication, mirroring, error protection and others. This information may be obtained from storage operating system 107 and/or from data structure 142.

In block B266, the management layer 138 checks the profile data structure 142A to determine if any of the stored storage profiles matches the features of requested storage. If yes, then the requested storage is assigned to the appropriate profile in block B268. If not, then in block B270, the management layer 138 generates a new storage profile type and creates a name for the new storage profile. The storage profile data structure 142A is updated and in block B272, the requested storage is assigned to the profile generated in block B270.

FIG. 2G shows a process 278 for provisioning storage, according to one embodiment. The process begins in block B280 when the various VMs, management console 118, storage provider 116 and the storage system 108 are initialized and operational.

In block B282, a request for additional storage is received by storage provider 116. The request may specify the storage profile for the additional storage.

In block B284, based on the request, a user interface is provided to the VM for selecting a cluster, an aggregate and a Vserver that can host the requested storage profile. The management logic 138 checks data structure 142 to determine which cluster and aggregate may have storage that can accommodate the requested profile.

In block B286, the selected storage is provisioned and stored as part of the selected storage profile. The management logic 138 may also perform a re-discovery operation to update data structure 142, as described above with respect to FIG. 2E.

Storage System Node:

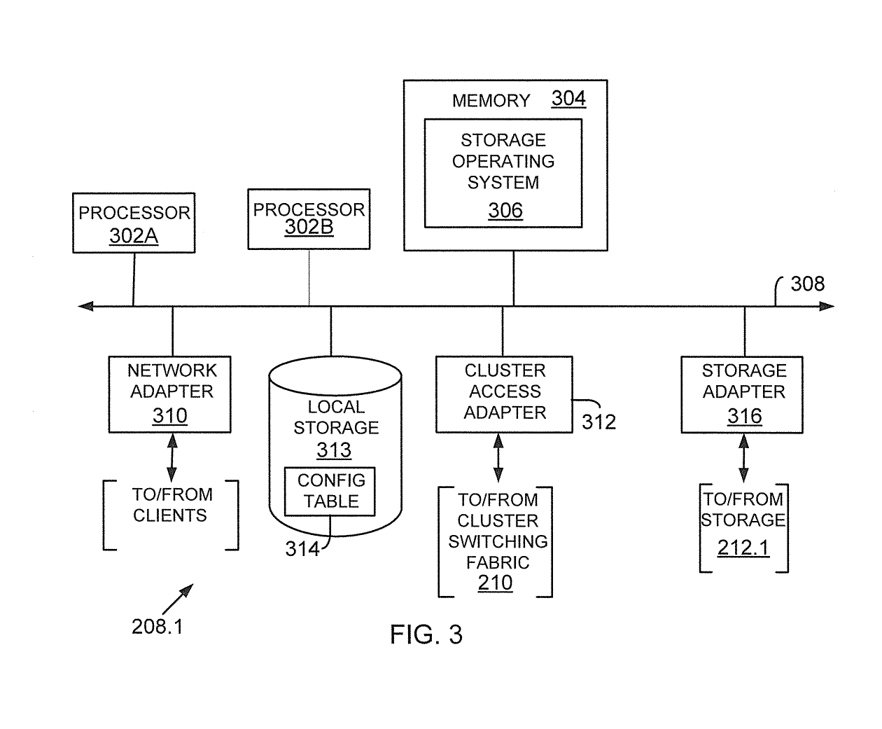

FIG. 3 is a block diagram of a node 208.1 that is illustratively embodied as a storage system comprising of a plurality of processors 302A and 302B, a memory 304, a network adapter 310, a cluster access adapter 312, a storage adapter 316 and local storage 313 interconnected by a system bus 308. Node 208.1 may be used to provide information regarding various storage devices to storage provider 116.

Processors 302A-302B may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware devices. The local storage 313 comprises one or more storage devices utilized by the node to locally store configuration information for example, in a configuration data structure 314.

The cluster access adapter 312 comprises a plurality of ports adapted to couple node 208.1 to other nodes of cluster 100. In the illustrative embodiment, Ethernet may be used as the clustering protocol and interconnect media, although it will be apparent to those skilled in the art that other types of protocols and interconnects may be utilized within the cluster architecture described herein. In alternate embodiments where the N-modules and D-modules are implemented on separate storage systems or computers, the cluster access adapter 312 is utilized by the N/D-module for communicating with other N/D-modules in the cluster 100.

Each node 208.1 is illustratively embodied as a dual processor storage system executing a storage operating system 306 (similar to 107, FIG. 1A) that preferably implements a high-level module, such as a file system, to logically organize the information as a hierarchical structure of named directories and files on storage 212.1. However, it will be apparent to those of ordinary skill in the art that the node 208.1 may alternatively comprise a single or more than two processor systems. Illustratively, one processor 302A executes the functions of the N-module 104 on the node, while the other processor 302B executes the functions of the O-module 106.

The memory 304 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions pertaining to the presented disclosure.

The storage operating system 306 portions of which is typically resident in memory and executed by the processing elements, functionally organizes the node 208.1 by, inter alia, invoking storage operation in support of the storage service implemented by the node.

The network adapter 310 comprises a plurality of ports adapted to couple the node 208.1 to one or more clients over point-to-point links, wide area networks, virtual private networks implemented over a public network (Internet) or a shared local area network. The network adapter 310 thus may comprise the mechanical, electrical and signaling circuitry needed to connect the node to the network. Illustratively, the computer network 206 may be embodied as an Ethernet network or a Fibre Channel network. Each client may communicate with the node over network 206 by exchanging discrete frames or packets of data according to pre-defined protocols, such as TCP/IP.

The storage adapter 316 cooperates with the storage operating system 306 executing on the node 208.1 to access information requested by the clients. The information may be stored on any type of attached array of writable storage device media such as video tape, optical, DVD, magnetic tape, bubble memory, electronic random access memory, micro-electro mechanical and any other similar media adapted to store information, including data and parity information. However, as illustratively described herein, the information is preferably stored on storage device 212.1. The storage adapter 316 comprises a plurality of ports having input/output (I/O) interface circuitry that couples to the storage devices over an I/O interconnect arrangement, such as a conventional high-performance, FC link topology.

Operating System:

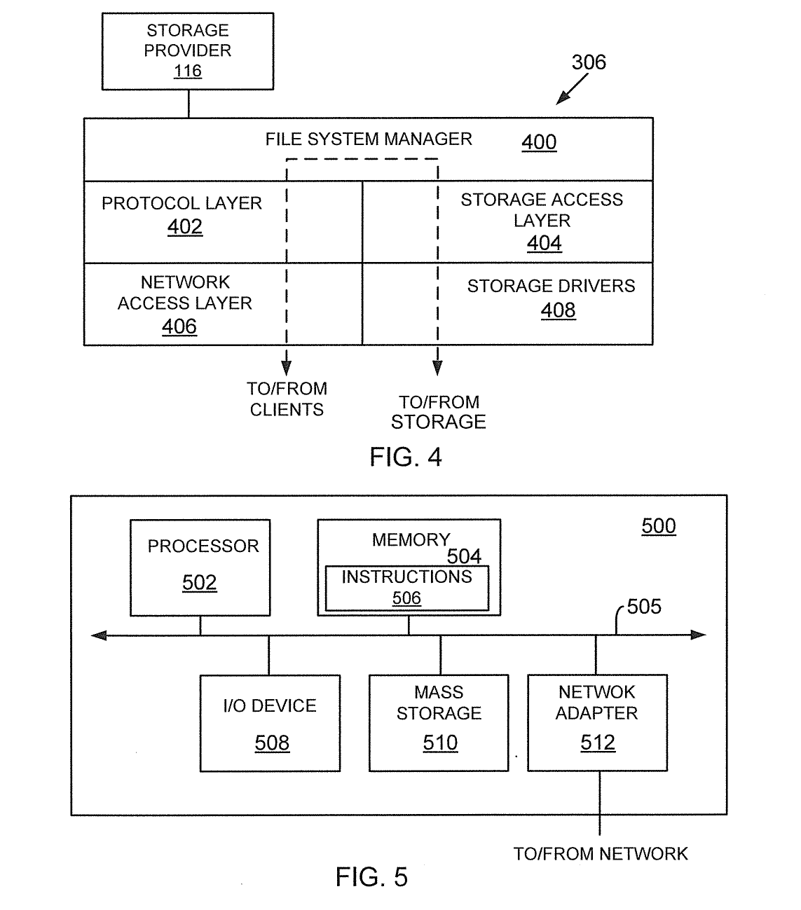

FIG. 4 illustrates a generic example of storage operating system 306 (or 107, FIG. 1A) executed by node 208.1, according to one embodiment of the present disclosure. The storage operating system 306 maintains information regarding various storage devices, storage volumes, LUNs, aggregates and the igroups. The information is provided to storage provider 116 for data structures 142/142A, as described above in detail.

In one example, storage operating system 306 may include several modules, or “layers” executed by one or both of N-Module 214 and D-Module 216. These layers include a file system manager 400 that keeps track of a directory structure (hierarchy) of the data stored in storage devices and manages read/write operation, i.e. executes read/write operation on storage in response to client requests.

Storage operating system 306 may also include a protocol layer 402 and an associated network access layer 406, to allow node 208.1 to communicate over a network with other systems, such as storage provider 116. Protocol layer 402 may implement one or more of various higher-level network protocols, such as NFS, CIFS, Hypertext Transfer Protocol (HTTP), TCP/IP and others, as described below.

Network access layer 406 may include one or more drivers, which implement one or more lower-level protocols to communicate over the network, such as Ethernet. Interactions between clients' and mass storage devices 212.1 are illustrated schematically as a path, which illustrates the flow of data through storage operating system 306.

The storage operating system 306 may also include a storage access layer 404 and an associated storage driver layer 408 to allow D-module 216 to communicate with a storage device. The storage access layer 404 may implement a higher-level storage protocol, such as RAID (redundant array of inexpensive disks), while the storage driver layer 408 may implement a lower-level storage device access protocol, such as FC or SCSI. The storage driver layer 408 may maintain various data structures (not shown) for storing information LUN, storage volume, aggregate and various storage devices.

As used herein, the term “storage operating system” generally refers to the computer-executable code operable on a computer to perform a storage function that manages data access and may, in the case of a node 208.1, implement data access semantics of a general purpose operating system. The storage operating system can also be implemented as a microkernel, an application program operating over a general-purpose operating system, such as UNIX® or Windows XP®, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly-attached to a client or host computer. The term “storage system” should therefore be taken broadly to include such arrangements in addition to any subsystems configured to perform a storage function and associated with other equipment or systems. It should be noted that while this description is written in terms of a write any where file system, the teachings of the present disclosure may be utilized with any suitable file system, including a write in place file system.

Processing System:

FIG. 5 is a high-level block diagram showing an example of the architecture of a processing system 500 that may be used according to one embodiment. The processing system 500 can represent storage provider 116, management console 118, host 102, or storage system 108. Note that certain standard and well-known components which are not germane to the present disclosure are not shown in FIG. 5.

The processing system 500 includes one or more processor(s) 502 and memory 504, coupled to a bus system 505. The bus system 505 shown in FIG. 5 is an abstraction that represents any one or more separate physical buses and/or point-to-point connections, connected by appropriate bridges, adapters and/or controllers. The bus system 505, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor(s) 502 are the central processing units (CPUs) of the processing system 500 and, thus, control its overall operation. In certain embodiments, the processors 502 accomplish this by executing software stored in memory 504. A processor 502 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 504 represents any form of random access memory (RAM), read-only memory (ROM), flash memory, or the like, or a combination of such devices. Memory 504 includes the main memory of the processing system 500. Instructions 506 implement the process steps described above with respect to FIGS. 2D-2G may reside in and execute (by processors 502) from memory 504.

Also connected to the processors 502 through the bus system 505 are one or more internal mass storage devices 510, and a network adapter 512. Internal mass storage devices 510 may be, or may include any conventional medium for storing large volumes of data in a non-volatile manner, such as one or more magnetic or optical based disks. The network adapter 512 provides the processing system 500 with the ability to communicate with remote devices (e.g., storage servers) over a network and may be, for example, an Ethernet adapter, a Fibre Channel adapter, or the like.

The processing system 500 also includes one or more input/output (I/O) devices 508 coupled to the bus system 505. The I/O devices 508 may include, for example, a display device, a keyboard, a mouse, etc.

Cloud Computing:

The system and techniques described above are applicable and useful in the upcoming cloud computing environment. Cloud computing means computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” is intended to refer to the Internet and cloud computing allows shared resources, for example, software and information to be available, on-demand, like a public utility.

Typical cloud computing providers deliver common business applications online which are accessed from another web service or software like a web browser, while the software and data are stored remotely on servers. The cloud computing architecture uses a layered approach for providing application services. A first layer is an application layer that is executed at client computers. In this example, the application allows a client to access storage via a cloud.

After the application layer, is a cloud platform and cloud infrastructure, followed by a “server” layer that includes hardware and computer software designed for cloud specific services. The storage provider 116(and associated methods thereof) and storage systems described above can be a part of the server layer for providing storage services. Details regarding these layers are not germane to the inventive embodiments.

Thus, a method and apparatus for managing storage profiles have been described. Note that references throughout this specification to “one embodiment” or “an embodiment” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics being referred to may be combined as suitable in one or more embodiments of the disclosure, as will be recognized by those of ordinary skill in the art.

While the present disclosure is described above with respect to what is currently considered its preferred embodiments, it is to be understood that the disclosure is not limited to that described above. To the contrary, the disclosure is intended to cover various modifications and equivalent arrangements within the spirit and scope of the appended claims.

What is claimed is:

1. A machine implemented method for a virtual machine environment, comprising:
maintaining a data structure by a storage provider module for assigning storage complying with a storage profile from among a plurality of storage profiles, where each storage profile is associated with varying level of storage capabilities;
evaluating available storage to determine if the available storage meets a requested storage profile;
assigning storage from the available storage when the storage meets the requested storage profile;
when the storage does not meet the requested storage profile, re-configuring other storage for presenting storage that meets the requested storage profile; and
when the other storage cannot be re-configured, provisioning new storage for presenting storage complying with the requested storage profile.

2. The method of claim 1, wherein the request is received from a management console at the storage provider module that interfaces with a storage system for maintaining the data structure.

3. The method of claim 1, wherein a storage system manages a storage pool from which storage is provisioned for the requested profile for a virtual machine as a virtual drive.

4. The method of claim 3, wherein the management console interfaces with a virtual machine monitor for presenting the virtual drive.

5. The method of claim 1, wherein the storage provider includes a processor executable management logic layer that uses the data structure for managing the plurality of storage profiles.

6. A machine implemented method, comprising;
maintaining a data structure for storing information regarding a plurality of storage volumes, where storage space associated with the storage volumes is presented as virtual drives to a plurality of virtual machines, each storage volume being associated with a storage profile from among a plurality of storage profiles and each storage profile having varying storage capabilities;
a processor executable management layer of a storage provider module interfacing with a storage operating system for receiving information regarding the storage volumes;
determining if the storage volumes comply with the storage profiles associated with storage that is presented to one or more virtual machines; and
reconfiguring non-compliant storage by associating certain virtual drives to storage volumes that meet an expected storage profile.

7. The method of claim 6, wherein the management layer updates the data structure after non-compliant storage is reconfigured.

8. The method of claim 6, wherein the management layer interfaces with a management console that is used to manage and configure the plurality of virtual machines in a virtual machine environment.

9. The method of claim 8, wherein the management layer notifies the management console when the non-compliant storage cannot be reconfigured.

10. The method of claim 6, wherein the data structure stores attributes that are associated with each storage profile and the management layer uses the data structure to determine if storage assigned to each storage profile complies with each storage profile.

11. A machine implemented method for presenting storage to a virtual machine, comprising:
allocating a storage volume to an existing profile, when the existing profile meets attributes for a requested storage; and
generating a new profile when an existing profile does not meet the attributes and assigning the storage volume to the new profile.

12. The method of claim 11, further comprising:
interfacing with a storage operating system to receive information regarding a plurality of storage volumes for allocating the storage volume to the new profile.

13. The method of claim 11, wherein a request for the requested storage is received from a management console at a storage provider module that communicates with a storage system for maintaining a data structure based on which the storage volume is assigned to the existing profile or the new profile.

14. The method of claim 11, wherein a storage system manages a storage pool from which the storage volume is provisioned for the existing profile and the new profile.

15. The method of claim 13, wherein the management console is used to manage and configure a plurality of virtual machines in a virtual machine environment.

16. The method of claim 13, wherein the storage provider module includes a processor executable management logic layer that uses the data structure for managing the new and the existing profiles.

17. A system, comprising:
a storage provider module interfacing with a storage system that manages storage space and a management console that manages a plurality of virtual machines;
wherein the storage provider module maintains a data structure for assigning storage for a virtual machine complying with a storage profile from among a plurality of storage profiles, where each storage profile is associated with varying level of storage capabilities;
evaluates available storage to determine that the available storage meets a requested storage profile; and
wherein when the available storage does not meet the requested storage profile, reconfigures other storage for presenting storage that meets the requested storage profile; and when the other storage cannot be reconfigured, provisions new storage from a storage pool for presenting storage complying with the requested storage profile.

18. The system of claim 17, wherein a storage operating system for the storage system manages the storage pool from which storage is provisioned for the requested profile.

19. The system of claim 17, wherein the storage provider module includes a processor executable management logic layer that uses the data structure for managing the plurality of storage profiles.

20. The system of claim 19, wherein the management console interfaces with a virtual machine monitor for presenting storage complying with the requested profile as a virtual drive.
